(19) United States
(12) Patent Application Publication
(10) Pub. No.: US 2019/0152802 A1
(43) Pub. Date: May 23, 2019

(54) FLUID FILTRATION SYSTEM AND METHOD

(71) Applicant: SST Systems, Inc.

(72) Inventor: Robert G. Rock, Sturgeon Bay, WI (US)

(21) Appl. No.: 16/251,433

(22) Filed: Jan. 18, 2019

Related U.S. Application Data
(62) Division of application No. 15/136,513, filed on Apr. 22, 2016.
(60) Provisional application No. 62/152,379, filed on Apr. 24, 2015.

(51) Int. Cl. C02F 1/00; B01D 61/14; C02F 1/44

(52) U.S. Cl. CPC C02F 1/008; B01D 61/142; C02F 1/004; C02F 2103/10; C02F 2201/005; B01D 2315/10; C02F 1/441

(57) ABSTRACT

A re-configurable filtration system includes a system inlet, first and second filters, a plurality of valves, a sensor, and a controller. Each filter has a feed inlet in fluid communication with the system inlet, a permeate outlet, and a concentrate outlet. The plurality of valves are switchable to define a first configuration in which the first filter and the second filter are arranged in fluid parallel and a second configuration in which the first filter and the second filter are arranged in fluid series. A sensor is operable to measure a property of the fluid within the system and to output a corresponding electrical signal. The controller can be operable to receive the electrical signal from the sensor and, in response, to switch the plurality of valves between the first configuration and the second configuration.

### CROSS-REFERENCE TO RELATED APPLICATION

This application is a divisional of co-pending U.S. patent application Ser. No. 15/136,513, filed Apr. 22, 2016, which claims the benefit of U.S. Provisional Patent Application No. 62/152,379, filed Apr. 24, 2015, the entire contents of both of which are incorporated by reference herein.

### FIELD OF THE INVENTION

The present invention relates to fluid filtration systems and methods, and in some aspects relates to fluid filtration systems and methods for fracking water treatment.

### BACKGROUND OF THE INVENTION

Hydraulic fracking is a process used in wells in which fluid (typically including large amounts of water) fractures shale and other rock for extraction of oil and gas. Fracking water, or flowback water, is water that has previously been pumped into the ground (e.g., shale formation) and has returned to the surface. Fracking water initially exits the well at a high flow rate and with low salinity, and as time passes and the flow rate of fracking water exiting the well decreases, the salinity of the fracking water also increases. The fracking water generally contains dissolved solids, chemicals and other precipitants that make treating and disposing of the water costly, especially in large quantities. The majority of the chemicals and suspended solids are removed using chemical precipitation, coagulation, and/or flocculation processes. However, after most materials are removed from the water, sodium chloride (salt) typically remains in the water in high concentration. Sodium chloride is not removed in the above-mentioned processes, and therefore requires a separate process to remove.

Although the removal of salt from fracking water is a significant challenge for the energy industry, similar challenges exist for the removal of salt and other dissolved minerals from water in other processes. A need therefore exists for improved systems and methods for filtering salt from water, such as in applications where the flow and salinity of the water changes significantly over time.

### SUMMARY OF THE INVENTION

The present invention provides, in one aspect, a re-configurable water filtration system that includes a primary water inlet, a first filter and a second filter. The first filter has a first feed inlet in fluid communication with the primary water inlet, a first permeate outlet, and a first concentrate outlet. The second filter has a second feed inlet in fluid communication with the primary water inlet, a second permeate outlet, and a second concentrate outlet. The re-configurable water filtration system further includes a plurality of valves, a plurality of sensors and a controller. The plurality of valves are switchable to define a first configuration, in which the first filter and the second filter are arranged in fluid parallel and a second configuration, in which the first filter and the second filter are arranged in fluid series. At least one sensor measures at least one property of the water within the system and outputs at least one corresponding electrical signal. The controller is operable to receive the at least one electrical signal from the at least one sensor and, in response, to switch the plurality of valves between the first configuration and the second configuration.

The present invention provides, in another aspect, a re-configurable water filtration system that includes a primary water inlet, a permeate storage unit, and a concentrate storage unit. The re-configurable water filtration system further includes a first filter, a second filter, a first pump and a second pump. The first filter has a first feed inlet configured to receive a flow of water from the primary water inlet, a first permeate outlet configured to direct permeate water to the permeate storage unit, and a first concentrate outlet configured to direct concentrate water to the concentrate storage unit. The second filter has a second feed inlet configured to receive a flow of water from the primary water inlet, a second permeate outlet configured to direct permeate water to the permeate storage unit, and a second concentrate outlet configured to direct concentrate water to the concentrate storage unit. The first pump is configured to pump water through the first filter. The second pump is configured to pump water through the second filter. The re-configurable water filtration system further includes a plurality of valves, a salinity sensor, a flow sensor and a controller. The plurality of valves are switchable to define a first configuration in which the first filter and the second filter are arranged in fluid parallel, and further defines a second configuration in which the first filter and the second filter are arranged in fluid series. The salinity sensor is operable to measure a salinity concentration of the water and output an electrical signal corresponding to the measured salinity concentration. The flow sensor is operable to measure a flow rate of the water and output an electrical signal corresponding to the measured flow rate. The controller is operable to receive the electrical signals from the salinity sensor and flow sensor and to switch the plurality of valves between the first configuration and the second configuration based upon the electrical signals.

The present invention provides, in yet another aspect, a method of operating a water filtration system. The method includes transmitting fracking water from a well bore to the water filtration system, and filtering the fracking water through the water filtration system in a first configuration in which a first filter and a second filter are in fluid parallel such that the fracking water flows from a primary inlet of the water filtration system to a first feed inlet of a first filter and also flows from the primary inlet to a second feed inlet of a second filter. The fracking water flows out a first permeate outlet and a first concentrate outlet of the first filter, and flows out a second permeate outlet and a second concentrate outlet of the second filter. A property of the water filtration system is measured with a sensor, the property relating to the fracking water flowing therein. In response to the measured property, the water filtration system is switched from the first configuration to a second configuration. The fracking water is filtered through the water filtration system in the second configuration in which the first and second filters are in fluid series. Filtering the fracking water in the second configuration includes flowing the fracking water from the primary inlet to the first feed inlet of the first filter and flowing the fracking water from the first permeate outlet of the first filter to the second feed inlet of the second filter.

Other features and aspects of the invention will become apparent by consideration of the following detailed description and accompanying drawings.

### BRIEF DESCRIPTION OF THE DRAWINGS

FIG. 1 is a schematic view of a fluid filtration system.

FIG. 2 is a schematic view of the fluid filtration system of FIG. 1, showing the fluid filtration system in a parallel filtration configuration.

FIG. 3 is a schematic view of the fluid filtration system of FIG. 1, showing the fluid filtration system in a series filtration configuration.

FIG. 4 is a flow diagram illustrating a method of operating the fluid filtration system of FIG. 1.

Before various embodiments of the invention are explained in detail, it is to be understood that the invention is not limited in its application to the details of construction and the arrangement of components set forth in the following description or illustrated in the accompanying drawings. The invention is capable of other embodiments and of being practiced or of being carried out in various ways. Also, it is to be understood that the phraseology and terminology used herein is for the purpose of description and should not be regarded as limiting.

### DETAILED DESCRIPTION

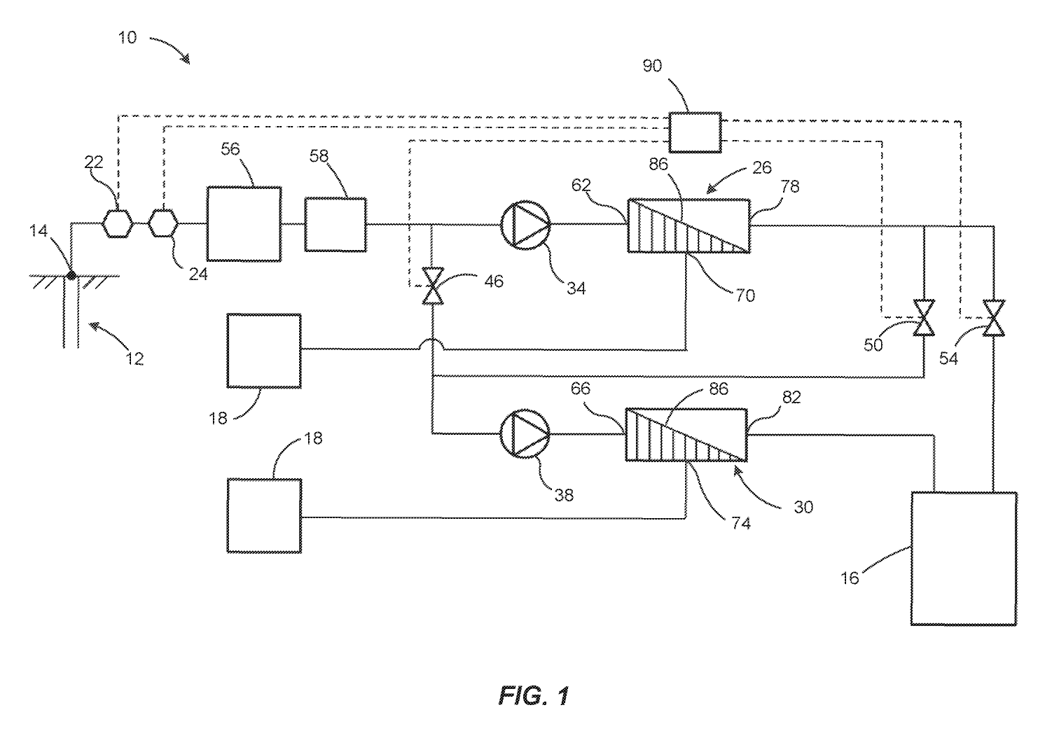

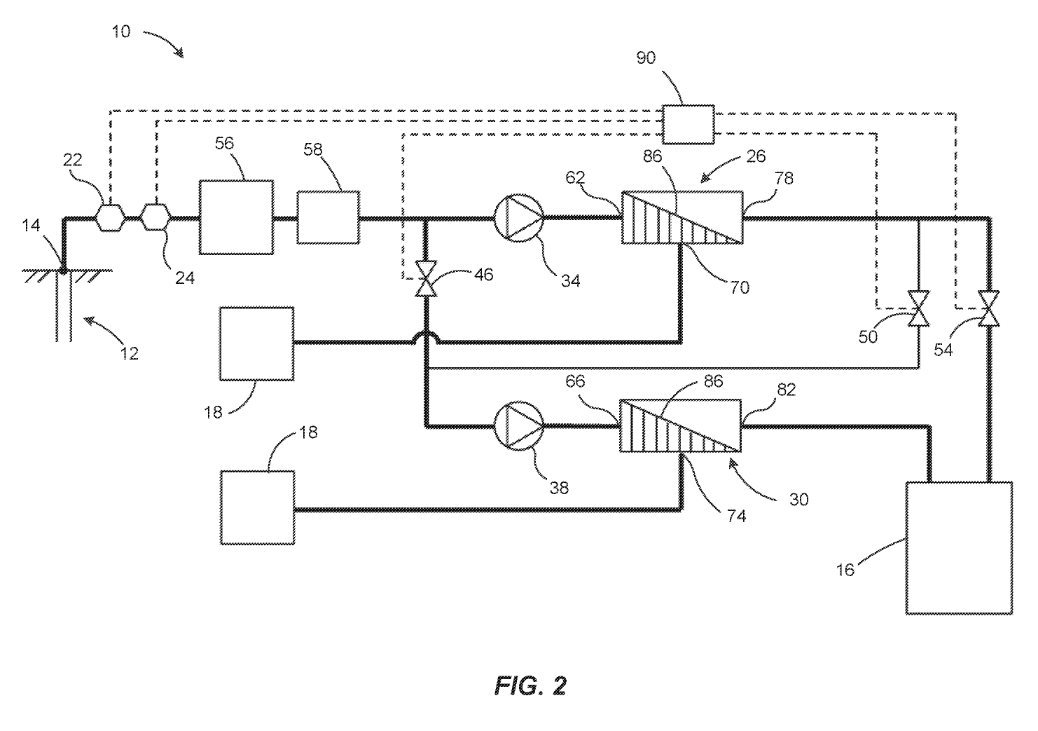

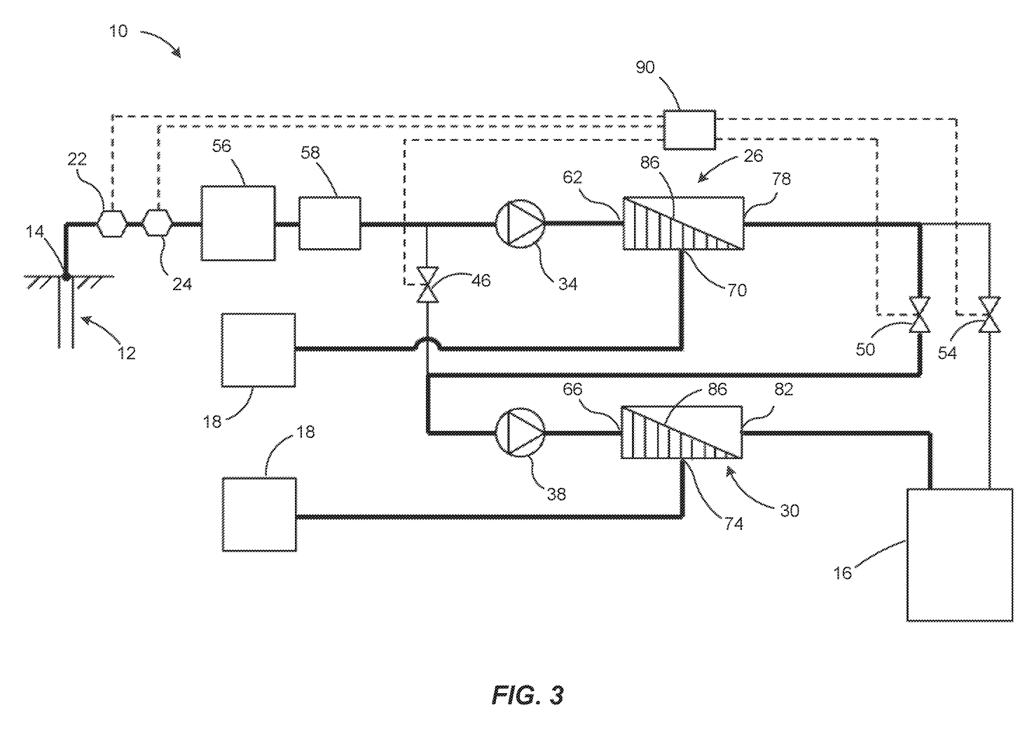

FIGS. 1-3 illustrate a fluid filtration system 10 for removing salt and lowering the salinity of water, such as fracking water (i.e., flowback water from a gas shale well). In some constructions, the fluid filtration system 10 automatically changes between a parallel filtration configuration (e.g., maximum flow configuration) as shown in FIG. 2, and a series filtration configuration (e.g., maximum salt rejection configuration) as shown in FIG. 3.

With reference to FIG. 1, the illustrated fluid filtration system 10 receives fracking water from a well bore 12 at a system inlet 14 for the fluid filtration system 10, referred to herein as the primary inlet 14. The fluid filtration system 10 includes at least one permeate storage unit or tank 16, and at least one concentrate storage unit or tank 18. The illustrated fluid filtration system 10 further includes at least one sensor 22, 24 to measure at least one property of the fluid filtration system 10 relating to the fracking water flowing within the fluid filtration system 10. The illustrated fluid filtration system 10 further includes first and second filters 26, 30 located downstream of the primary inlet 14. As illustrated in FIGS. 1-3, the primary inlet 14 can be at a point of exit of the well bore 12 to directly receive fracking water from the well bore 12. In some embodiments, the fracking water may be temporarily stored in a collection reservoir or a plurality of tanks before being pumped to the primary inlet 14 of the fluid filtration system 10. In some embodiments, the fracking water may pass through pre-treatment operations after leaving the well bore 12 and before being fed to the fluid filtration system 10 at the primary fracking water inlet 14.

In the parallel flow configuration of FIG. 2, the second filter 30 is arranged downstream of the primary inlet 14 in parallel with the first filter 26. In the series flow configuration of FIG. 3, the second filter 30 is arranged downstream of the first filter 26. The illustrated fluid filtration system 10 further includes a first pump 34 upstream of the first filter 26, a second pump 38 upstream of the second filter 30, and a plurality of valves including first, second and third control valves 46, 50, 54. With continued reference to the exemplary embodiment of FIGS. 1-3, the control valves 46, 50, 54 are located such that when the first and the third control valves 46, 54 are open and the second control valve 50 is closed, the fluid filtration system 10 is in the parallel flow configuration as shown in FIG. 2. Conversely, when the state of the control valves 46, 50, 54 is reversed (i.e. the first and the third control valves 46, 54 are closed and the second control valve 50 is open), the fluid filtration system 10 is configured in the series flow configuration as shown in FIG. 3.

The fluid filtration system 10 may further include one or more cartridge filters 58 downstream of a pre-treatment feed tank 56 to initially remove particles from the incoming water that may damage the filters 26, 30. The pre-treatment feed tank 56 provides a temporary storage unit for the water (e.g., fracking water exiting the well bore 12) before it flows to the cartridge filter 58. In some embodiments of the fluid filtration system 10, the cartridge filter 58 filters out substantially all (e.g., 99.9 percent) particles that are greater than 40 microns, however, a different capacity microfilter that filters out particles of other sizes may instead be used. In some embodiments, pre-treatment of the water before the filters 26, 30 includes other pre-treatment operations (e.g. nanofiltration, reverse osmosis, or other suitable filtration operations). In alternate embodiments, either or both of the cartridge filter 58 and the pre-treatment feed tank 56 may be excluded from the fluid filtration system 10.

The first and second filters 26, 30 include corresponding feed flow inlets 62, 66, concentrate outlets 70, 74, and permeate outlets 78, 82. Each filter 26, 30 further includes a semi-permeable membrane 86 that separates the feed flow inlet 62, 66 from the permeate outlet 78, 82. Each of the filters 26, 30 can be a cross-flow filter. The membrane 86 may include layers of individual membrane leaves separated by spacers, although other types and arrangements of filter media can instead be used. In the case of cross-flow, the concentrate outlet 70, 74 is located on the same side of the membrane 86 as the feed flow inlet 62, 66 such that the fracking water that comes from the feed flow inlet 62, 66 passes over the membrane 86 tangentially at a positive pressure relative to the permeate outlet 78, 82. A portion of the water passes through the membrane 86 and out the permeate outlet 78, 82 as permeate water. However, sodium chloride particles in the water cannot pass through the membrane 86, and instead flow out the concentrate outlet 70, 74 with a portion of the water as concentrate water or retentate. As such, water exiting the permeate outlet 78, 82 as permeate water has a substantially decreased salinity, and water exiting the concentrate outlet 70, 74 as concentrate water has a substantially increased salinity compared to the incoming water as provided to the fluid filtration system 10.

An advantage of using cross-flow filters is that sodium chloride or other small particles that would blind or foul other types of filters (e.g., a dead-end filter), thereby lowering the efficiency and production of permeate, are substantially washed away by the tangential flow of the water over the membrane 86. The use of cross-flow filters 26, 30 also decreases how often the filters have to be replaced compared to other types of filtration. The fluid filtration system 10, therefore, can be operated as a continuous process for extended periods of time without regular stoppages to replace filters as the filters are obstructed with particles, as is the case with other types of filtration systems (e.g. dead end filtration systems).

Although cross-flow filters 26, 30 are used in the embodiment of FIGS. 1-3 and in other embodiments described herein, it will be appreciated that other types of filtration can instead be used. The membranes 86 of the filters 26, 30 can take a variety of forms, including but not limited to polymeric, carbon composites, ceramic, and graphene, an atomic-level honeycomb lattice.

The first and second fluid pumps 34, 38 are located upstream of the respective first and second feed flow inlets 62, 66 of the first and second filters 26, 30. Each of the first and second fluid pumps 34, 38 operates to drive a flow of water that enters the filters 26, 30 so that there is a positive pressure gradient across the membranes of the filters 26, 30. Although the first and second pumps 34, 38 can be identical, in some embodiments the first and second pumps 34, 38 are not identical, and can have different sizes, be of different types, have different flow capacities, and the like. Regardless of whether the pumps 34, 38 are identical or different from one another, in some embodiments the pumps 34, 38 may be operated to induce two or more different flow rates (e.g. 30 gallons per minute vs. 45 gallons per minute). In one embodiment for example, the first pump 34 has a higher flow capacity than the second pump 38 to provide a positive pressure gradient across the membrane of both the first and the second filters 26, 30 when in the maximum salt rejection configuration.

The permeate storage unit 16, in which the water with reduced salinity is stored, is located downstream of the permeate outlets 78, 82. The water that is stored in the permeate storage unit 16 may then be reused in additional hydraulic fracking operations, reducing the amount of water that has to be transported and processed offsite. The permeate storage unit 16 may be a mobile tank, an onsite tank or pond, or any other suitable portable or non-portable large fluid storage device. In the maximum flow configuration, the permeate outlets 78, 82 of the first and the second filters 26, 30 are coupled to the permeate storage unit 16 in parallel. In the maximum salt rejection configuration, the state of each valve 46, 50, 54 is switched so that the permeate outlet 78 of the first filter 26 is routed to supply water to the feed inlet 66 of the second filter 30, while the permeate outlet 82 of the second filter 30 continues to output permeate water having reduced salinity into the permeate storage unit 16. In other embodiments, the fluid lines transporting permeate from the filters 26, 30 supply permeate to different permeate storage units. Also, although one or more permeate storage units can be used, it should be noted that in other embodiments permeate is not stored or held, but is instead transported to downstream operations for immediate use and/or processing.

In the illustrated embodiment, concentrate storage units 18 are located downstream of each of the concentrate outlets 70, 74 of the filters 26, 30 and contain concentrate water with high salinity that is discharged from the concentrate outlets 70, 74. In some embodiments, the concentrate outlets 70, 74 may output concentrate to a single concentrate tank, or any number of concentrate tanks. In the illustrated embodiment, the fluid filtration system 10 is a continuous flow system where the water exiting the concentrate outlets 70, 74 and the permeate outlets 78, 82 of the filters 26, 30 exits as concentrate water and permeate water, and is stored separately in the concentrate storage units 18 and permeate storage unit 16 respectively. This type of system can be a steady-state system, as the salinity of water entering the feed inlets 62, 66 of the filters 26, 30, the salinity of water exiting the concentrate outlets 70, 74, and the salinity of water exiting the permeate outlets 78, 82 each remains at a steady value. In alternate embodiments of the fluid filtration system 10, the concentrate water may be recirculated upstream of the filters 26, 30 to further filter out more sodium chloride. Such alternate embodiments of the system may be “bleed and feed” systems in which concentrate water exiting the concentrate outlets 70, 74 of the filters 26, 30 is recirculated back through the system 10 by transporting fluid from the concentrate outlets 70, 74 to the pre-treatment feed tank 56 or to a location upstream of the filters 26, 30. Such systems can be unsteady, as the salinity of the water both entering and exiting the cross flow filters 26, 30 can increase with time.

With continued reference to the illustrated embodiment of FIGS. 1-3, the first control valve 46 is located in a flow path between the cartridge filter 58 (or otherwise a location upstream of the first pump 34) and the second pump 38, such that water can flow directly from the primary inlet 14 to the feed flow inlet 66 of the second filter 30 when the first control valve 46 is open. In this embodiment, the second control valve 50 is located in a flow path between the permeate outlet 78 of the first filter 26 and the second pump 38, such that permeate water can flow from the permeate outlet 78 of the first filter 26 through the second pump 38 and into the feed inlet 66 of the second filter 30 when the second control valve 50 is open. Also in this embodiment, the third control valve 54 is located in a flow path extending between the permeate outlet 78 of the first filter 26 and the permeate storage unit 16 such that permeate water flows directly from the permeate outlet 78 of the first filter 26 into the permeate storage unit 16 (i.e., without passing through the second filter 30) when the third control valve 54 is open. All of the control valves 46, 50, 54 can be connected to a controller 90 as part of a control system so that the states of any or all of the control valves 46, 50, 54 may be automatically switched from open to closed, and vice versa. Alternatively, the control valves 46, 50, 54 may be manually controlled to switch between open and closed states to reconfigure the fluid filtration system 10. The first, second, and third control valves 46, 50, 54 may be constructed as entirely separate valves as depicted schematically in the figures, or one or more of the control valves 46, 50, 54 may be integrated as a unit (e.g., a multi-valve unit that receives a single input from the controller 90). As used herein, an integrated multi-valve unit provides a plurality of valves in the sense that multiple flow paths can selectively be opened and blocked, even if all of the valve members performing the switching are integrated into a single valve spool, for example, which prevents independent switching.

The at least one sensor 22, 24 of the fluid filtration system 10 may be one or more salinity sensors 22 alternatively or in combination with one or more flow sensors 24 to measure the salinity concentration and the flow rate of the water, respectively. The sensors 22, 24 can be located at or adjacent the primary inlet 14 so as to monitor the respective properties at the point of entry to the fluid filtration system 10. When the primary inlet 14 is directly coupled to a fracking well bore 12, the sensors 22, 24 effectively also monitor the actual characteristics (e.g., salinity concentration and/or flow rate) of the fracking water exiting the well bore 12. In other embodiments, the salinity sensor 22 and the flow sensor 24 may be located anywhere in the fluid filtration system 10, such as adjacent the respective filters 26, 30, either upstream or downstream. The salinity sensor 22 and the flow sensor 24 are connected to the controller 90 such that, based at least in part upon the respective outputs (e.g., electrical signals sent to the controller 90) of the salinity sensor 22 and/or the flow sensor 24, the controller 90 switches the configuration of the fluid filtration system 10 by switching the configuration of the control valves 46, 50, 54. In one construction, for example, the controller 90 monitors both the salinity concentration and the flow rate of the water with the sensors 22, 24 during processing in order to control the states of the control valves 46, 50, 54. If the salinity concentration of the water surpasses a predefined upper limit and/or the flow rate of the water decreases below a predefined lower limit during operation in the maximum flow configuration (FIG. 2), the controller 90 switches the state of each control valve 46, 50, 54 such that the fluid filtration system 10 is reconfigured to the maximum salt rejection configuration (FIG. 3). More specifically, the first and third control valves 46, 54 are changed from open to closed and the second control valve 50 is opened from its closed state. The controller 90 can be programmed to switch the state of the control valves 46, 50, 54 in this manner once both the salinity concentration of the water surpasses the predefined upper limit and the flow rate of the water drops below the predefined lower limit as described above. Alternately, the controller 90 can be programmed to switch the configuration in response to a first occurring one of either of the above mentioned predefined conditions for salinity concentration or flow rate. In some constructions, the fluid system 10 includes only one type of sensor (e.g., salinity sensor 22 or flow sensor 24), and correspondingly only one property is monitored by the controller 90 to control switching the state of the control valves 46, 50, 54. In other constructions, salinity and flow sensors 22, 24 are both provided, but the controller 90 is programmed such that only one of salinity concentration or flow rate is a primary controlling property with the other serving only as a secondary or back-up controlling property.

If the salinity concentration decreases and/or the flow rate of the fracking water increases, respectively, back within a corresponding predefined allowable range for parallel filtration, the fluid filtration system 10 can be reconfigured (e.g., automatically by control of the controller 90 upon the signal(s) from the sensor(s) 22, 24) back into the maximum flow configuration of FIG. 2 by closing the second control valve 50 and opening the first and third control valves 46, 54. The controller 90 can operate to switch the state of the control valves 46, 50, 54 in this manner once both the salinity concentration of the water falls below a predefined upper limit (e.g., the predefined upper limit described above, or another predefined upper limit) and the flow rate of the water increases past a predefined lower limit (e.g., the predefined lower limit described above, or another predefined lower limit), or in response to either such limit.

In some embodiments there are multiple salinity sensors 22 and/or multiple flow sensors 24 in different locations in the system 10 so that respective outputs can be combined or correlated by the controller 90 to determine when to change between parallel and series configurations as described above. In some constructions, the salinity sensor 22 may operate by sensing the conductivity of the water which can then be correlated to salinity concentration by the controller 90. Other types of salinity sensors can instead be used as desired. Additionally, the predefined upper limit for the salinity concentration of the water and the predefined lower limit for the flow rate of the water may be variable or interdependent.

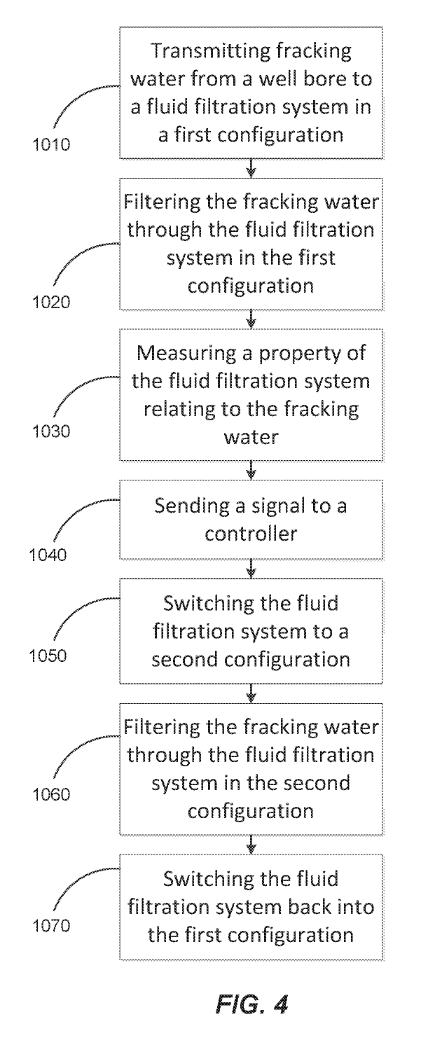

With reference to FIG. 4, in step 1010 of a method for operating the fluid filtration system 10, fracking water is transmitted from the well bore 12 to the fluid filtration system 10. In step 1020, the fracking water is filtered through the fluid filtration system 10 configured in a parallel flow configuration (maximum flow rate configuration). As shown in FIG. 3, in the maximum flow rate configuration of the system, fracking water initially enters the fluid filtration system 10 at the primary inlet 14. In the illustrated embodiment, the fracking water is temporarily stored in the pre-treatment tank 56 before passing through the cartridge filter 58. The fracking water then splits into two fracking water flow paths. The first flow path extends through the first pump 34 to the feed flow inlet 62 of the first filter 26. The second flow path extends through the first control valve 46 and the second pump 38 to the feed flow inlet 66 of the second filter 30. Each of the first and second flow paths are split again in the respective one of the first and second filters 26, 30 such that highly salinized concentrate water exits the respective concentrate outlets 70, 74, and permeate water with low salinity exits the respective permeate outlets 78, 82 of the cross flow filters 26, 30. The concentrate water is discharged to the concentrate storage unit 18 or is recirculated into the fluid filtration system 10 upstream of the cross flow filters 26, 30. Meanwhile, the permeate water is discharged into the permeate storage unit 16.

In step 1030, as fracking water flows into the fluid filtration system 10, properties of the fluid filtration system 10 relating to the fracking water, such as salinity and/or flow rate, are measured by the sensors 22, 24. In step 1040, a electrical signal corresponding to at least one of the measured properties of the fracking water is sent from at least one of the sensors 22, 24 to the controller 90. As the amount of water in the well bore 12 is depleted with time, the flow rate of the fracking water through the fluid filtration system 10 can decrease and the salinity concentration of the fracking water in the fluid filtration system 10 can increase. In some embodiments, the flow rate of the fracking water leaving the well bore 12 is equivalent to the flow rate of the fracking water within the fluid filtration system 10. In other embodiments, the flow rate of the fracking water within the fluid filtration system 10 is proportional to the flow rate of the fracking water leaving the well bore 12 and varies proportionally.

In step 1050, the illustrated fluid filtration system 10 is automatically switched to a series flow configuration (maximum salt rejection configuration) (FIG. 3) by the controller 90 when the flow rate of fracking water is below the predefined lower limit and the salinity concentration of the fracking water is above the predefined upper limit as described above. In the illustrated embodiment, the controller 90 actuates the valving arrangement to switch the fracking water filtration system 10 from the maximum flow configuration to the maximum salt rejection configuration.

In step 1060, the fracking water is filtered by the fluid filtration system in the maximum salt rejection configuration. As shown in FIG. 3, in the maximum salt rejection configuration of the system 10, the second flow path is blocked by closing the first control valve 46 such that fracking water only flows from primary inlet 14 along the first flow path to the first feed inlet 62 of the first filter 26. A third flow path extending from the first permeate outlet 78 of the first filter 26 to the second feed inlet 66 of the second filter 30 is opened by opening the second control valve 50. In addition, the third control valve 54 is closed to inhibit fracking water from flowing into the permeate storage unit 16 from the first permeate outlet 78 of the first filter 26. Accordingly, in the maximum salt rejection configuration of the system 10, fracking water is initially received from the well bore 12 at the primary inlet 14. Then, in the illustrated embodiment, is temporarily stored in the pre-treatment tank 56 before passing through the cartridge filter 58. The fracking water then flows through the first pump 34 to the feed flow inlet 62 of the first filter 26. The flow of fracking water splits in the first filter 26 such that highly salinized concentrate water flows out the concentrate outlet 70 to the concentrate storage units 18, and permeate water with low salinity flows out the permeate outlet 78 of the first filter 26. The permeate water from the first filter 26 flows along the third flow path and becomes the input to the second filter 30 as it flows through the second control valve 50 and the second pump 38, to the feed flow inlet 66 of the second filter 30. The flow splits again in the second filter 30 such that the concentrate water with higher salinity flows out the concentrate outlet 74 to the concentrate storage units 18, and the remaining permeate water with lower salinity flows out the permeate outlet 82 and is discharged into the permeate storage unit 16.

In step 1070, the fluid filtration system 10 is switched back to the maximum flow configuration (FIG. 2). In some embodiments, the fluid filtration system 10 is automatically switched back to the maximum flow configuration by the controller 90 if the flow rate of fracking water returns above the predefined lower limit and the salinity concentration of the fracking water returns below the predefined upper limit as described above.

Though the fluid filtration system 10 is illustrated as using two filters that are switched between a parallel flow configuration and a series flow configuration, in other embodiments there may be additional filters that may be switched between being in parallel and series (e.g., all three being in parallel in one configuration and switchable to all be in series in another configuration, and even to have two filters in parallel and a third filter in series with the first two filters in yet another configuration). Additionally, although the treated water in the system is illustrated as fracking water, the system is not limited in all aspects of the invention to reducing salinity of fracking water.

By providing a fluid filtration system 10 for fracking water treatment that automatically switches between a parallel configuration (maximum flow configuration) and a series configuration (maximum salt rejection configuration) based at least in part upon a monitored property of the fracking water of the system, the fluid filtration system 10 advantageously provides the ability to produce more permeate from fracking water throughout the flowback process, as the salinity of the fracking water increases and the flow rate of the fracking water decreases. This improves the efficiency of converting fracking water into permeate water that is then able to be reused in additional hydraulic fracking operations, therefore reducing the amount of fracking water that needs to be treated offsite and thus reducing cost. These and other advantages may be realized from one or more embodiments of the fluid filtration system 10 disclosed herein. Although the method shown in FIG. 4 and described in the several preceding paragraphs is directly applied to fracking water from a well bore, for which specific advantages of the fluid filtration system 10 can be realized, it should be noted that the process of FIG. 4 and the above description can also be performed on water from other sources. A separate description is not presented here for the sake of brevity, and it will be appreciated that the features of the method already discussed can be performed as described above, but with water from alternate sources.

Although aspects have been described in detail with reference to certain preferred embodiments, variations and modifications exist within the scope and spirit of one or more independent aspects as described. Various features of the invention are set forth in the following claims.

What is claimed is:

1. A method of handling fracking water at the site of a hydraulic fracking shale well bore, the method comprising:
transmitting fracking water exiting the well bore to a system inlet of a water filtration system;
filtering the fracking water through the water filtration system in a first configuration in which a first filter and a second filter are in fluid parallel such that the fracking water flows from the system inlet to a first feed inlet of a first filter and also flows from the system inlet to a second feed inlet of a second filter in fluid parallel, the fracking water flowing out a first permeate outlet and a first concentrate outlet of the first filter, and the fracking water flowing out a second permeate outlet and a second concentrate outlet of the second filter;
measuring a property of the water filtration system with a sensor, the measured property relating to the fracking water flowing therein;
in response to the measured property, switching the water filtration system from the first configuration to a second configuration; and
filtering the fracking water through the water filtration system in the second configuration, in which the first and second filters are in fluid series, wherein filtering the fracking water in the second configuration includes flowing the fracking water from the system inlet to the first feed inlet of the first filter and flowing the fracking water from the first permeate outlet of the first filter to the second feed inlet of the second filter.

2. The method of claim 1, further comprising sending a signal indicative of the measured property to a controller, and actuating a plurality of valves with the controller to switch the water filtration system from the first configuration to the second configuration.

3. The method of claim 2, wherein the actuation of the plurality of valves blocks a flow path from the system inlet to the second feed inlet of the second filter, and opens a flow path from the first concentrate outlet of the first filter to the second feed inlet of the second filter in the second configuration.

4. The method of claim 1, wherein the measured property is salinity concentration, and the switch of the fracking water filtration system from the first configuration to the second configuration is triggered when the salinity concentration surpasses a predefined salinity value.

5. The method of claim 1, wherein the measured property is total flow rate of fracking water flowing into the system inlet.

6. The method of claim 1, wherein the measured property is salinity concentration, the method further comprising measuring total flow rate of fracking water flowing into the system inlet with a further sensor, the switch of the water filtration system from the first configuration to the second configuration being triggered by the controller when the salinity concentration surpasses a predefined value and the total flow rate of fracking water into the system inlet drops below a predefined flow rate value as indicated by a signal from the further sensor.

7. The method of claim 1, wherein transmitting the fracking water from the well bore to the water filtration system includes transmitting the fracking water directly into the system inlet as the fracking water exits the well bore.

8. The method of claim 1, wherein transmitting the fracking water from the well bore to the water filtration system includes transmitting the fracking water from the well bore to at least one storage unit, and transmitting the fracking water from the at least one storage unit into the system inlet.

9. The method of claim 1, further comprising receiving the fracking water exiting the well bore throughout a flowback process of the well bore, wherein the water filtration system is maintained in the first configuration during an initial stage of the flowback process and wherein the water filtration system is maintained in the second configuration during a terminal stage of the flowback process.

10. The method of claim 1, wherein the first and second filters perform cross-flow filtration.

11. The method of claim 1, further comprising:
routing permeate water from the first and second permeate outlets to at least one permeate storage unit;
routing concentrate from the first and second concentrate outlets to at least one concentrate storage unit;
routing the permeate water for re-injection into the well bore; and
transporting the concentrate from the at least one concentrate unit for off-site treatment.

12. A method of handling fracking water at the site of a hydraulic fracking shale well bore, the method comprising:
transmitting fracking water exiting the well bore to a system inlet of a water filtration system;
filtering the fracking water through a plurality of cross-flow filters of the water filtration system in a first configuration in which the plurality of cross-flow filters are in fluid parallel;
measuring a property of the water filtration system with a sensor, the measured property relating to the fracking water flowing therein;
in response to a signal from the sensor indicative of the measured property being received by a controller, operating the controller to automatically switch the water filtration system from the first configuration to a second configuration in which the plurality of cross-flow filters are in fluid series;
filtering the fracking water through the water filtration system in the second configuration;
routing permeate water from the plurality of cross-flow filters to at least one permeate storage unit;
routing concentrate from the plurality of cross-flow filters to at least one concentrate storage unit;
routing the permeate water for re-injection into the well bore; and
transporting the concentrate from the at least one concentrate unit for off-site treatment.

13. The method of claim 12, wherein the controller operates to switch the water filtration system from the first configuration to a second configuration by commanding actuation of a plurality of switchable control valves.

14. The method of claim 13, wherein the actuation of the plurality of valves blocks a flow path from the system inlet to a feed inlet of a downstream one of the plurality of cross-flow filters, and opens a flow path from a concentrate outlet of an upstream one of the plurality of filters to the feed inlet of the downstream filter in the second configuration.

15. The method of claim 12, wherein the measured property is salinity concentration, and the switch of the fracking water filtration system from the first configuration to the second configuration is triggered by the controller when the salinity concentration surpasses a predefined salinity value.

16. The method of claim 12, wherein the measured property is total flow rate of fracking water flowing into the system inlet.

17. The method of claim 12, wherein the measured property is salinity concentration, the method further comprising measuring total flow rate of fracking water flowing into the system inlet with a further sensor, the switch of the water filtration system from the first configuration to the second configuration being triggered by the controller when the salinity concentration surpasses a predefined value and the total flow rate of fracking water into the system inlet drops below a predefined flow rate value as indicated by a signal from the further sensor.

18. The method of claim 12, wherein transmitting the fracking water from the well bore to the water filtration system includes transmitting the fracking water directly into the system inlet as the fracking water exits the well bore.

19. The method of claim 12, wherein transmitting the fracking water from the well bore to the water filtration system includes transmitting the fracking water from the well bore to at least one storage unit, and transmitting the fracking water from the at least one storage unit into the system inlet.

20. The method of claim 12, further comprising receiving the fracking water exiting the well bore throughout a flowback process of the well bore, wherein the water filtration system is maintained in the first configuration during an initial stage of the flowback process and wherein the water filtration system is maintained in the second configuration during a terminal stage of the flowback process.
